(19) United States
(12) Patent Application Publication
(10) Pub. No.: US 2011/0205069 A1
(43) Pub. Date: Aug. 25, 2011

(54) PET SAFETY WARNING RING

(76) Inventor: Shang Chia Liu, Taipei City (TW)

(21) Appl. No.: 13/027,270

(22) Filed: Feb. 15, 2011

(30) Foreign Application Priority Data
Feb. 25, 2010 (TW) 099203459

(51) Int. Cl. G08B 23/00

(52) U.S. Cl. 340/573.3

(57) ABSTRACT

A pet safety warning ring comprises a collar body, a vibration frequency sensor, an information transmission module, a warning flash device, a microcontroller chip, a sensing adjustment means and an ultrasonic transmitter. When a pet is moving, the vibration frequency sensor receives a vibration and transmits a message to the warning flash device to achieve the effect of warning a driving car about the existence of the pet. If the vibration frequency sensed by the warning ring reaches a specific value, the microcontroller chip will turn on the ultrasonic transmitter to emit a high-decibel ultrasonic wave, such that the pet will feel uncomfortable. When the pet slows down its movement, the ultrasonic transmitter will stop operating, so that the moving speed of the pet can be controlled to prevent an accident if the pet runs onto a road.

### BACKGROUND OF THE INVENTION

1. Field of the Invention

The present invention relates to a pet safety warning ring, and more particularly to a pet safety warning ring including a vibration sensor, a warning flash device and an ultrasonic transmitter installed thereon.

2. Description of the Related Art

Pet collar generally comes with the functions of controlling the movement of a pet as well as identifying and decorating the pet, and thus becomes an indispensable accessory of each pet. Most people treat their pet as one of the important members of their family and hope that technologies can shorten the distance between pets and humans. Improved collars are developed and introduced to enhance the interactions between humans and pets. For example, a speaker and a sensor are installed on the collar, and the sensor is provided for monitoring the pet's situations . If the pet (such as a dog) barks and produces noises, a pre-recorded pet owner's instruction is played to comfort the pet's emotion. Further, a chip is installed on the collar for identifying the pet, recording the pet's health conditions, as well as allowing pet owners to locate their pet. To prevent the pets from losing their way or missing, the collar may have a global positioning system function, such that the pet owner can know and control their pet's movements easily.

However, the moving space for pets in cities is very limited, and pets may chase each other in a park or on a road. Accidents are inevitable in sudden emergency situations, since the pets cannot be driven away from the dangerous situation in time, even if the pet owner has given oral warnings to them. In most situations, the pets may have gone too far or out of the pet owner's sight, so that the pet owners are unable to control the movement of their pets or prevent possible accidents at all.

### SUMMARY OF THE INVENTION

It is a primary objective of the invention to overcome the shortcomings of the prior art by providing a pet safety warning ring, comprising:

a collar body, having a locking element disposed at both ends of said collar body separately, and a warning ring being fixed onto a pet;

a vibration frequency sensor, disposed on said collar body;

an information transmission module, with an end as a receiving terminal coupled to a vibration frequency sensor, and another end as a transmitting terminal coupled to a warning flash device and a microcontroller chip;

a warning flash device, coupled to said information transmission module, for generating a light warning according to information read by the vibration frequency sensor;

a microcontroller chip, coupled to the information transmission module, for determining whether the ultrasonic transmitter is turned on;

a sensing adjustment means, coupled to the microcontroller chip; and

an ultrasonic transmitter, coupled to the microcontroller chip, for emitting an ultrasonic wave after a turn-on instruction is received.

Wherein, the ultrasonic transmitter emits an ultrasonic wave from 130 dB to 140 dB.

Wherein, the ultrasonic transmitter has a transmission frequency at least greater than 20000 HZ.

Wherein, the warning flash device has at least one outwardly emitted light beam.

In summation, the present invention has the following advantages and effects:

The pet safety warning ring of the present invention comprises the vibration frequency sensor for determining a pet's moving speed, when the vibration frequency of the pet's movement is measured.

The pet safety warning ring of the present invention comprises the warning flash device, wherein the information transmission module transmits the vibration frequency to the warning flash device to trigger its switch to achieve the effect of alerting a moving car about the existence of the pet.

The pet safety warning ring of the present invention comprises an ultrasonic transmitter, wherein if the vibration frequency reaches a specific value, the microcontroller chip will turn on the ultrasonic transmitter to emit a high-decibel ultrasonic wave, so that the pets will feel uncomfortable and stop its movement. As a result, the moving speed of the pets can be controlled to prevent accidents if the pets run onto a road.

### BRIEF DESCRIPTION OF THE DRAWINGS

FIG. 1 is a perspective view of the present invention;

FIG. 2 is an exploded view of the present invention;

FIG. 3 is a schematic view of a first preferred embodiment of the present invention;

FIG. 4 is a schematic view of a second preferred embodiment of the present invention; and

FIG. 5 is a schematic view of a third preferred embodiment of the present invention.

### DETAILED DESCRIPTION OF THE PREFERRED EMBODIMENTS

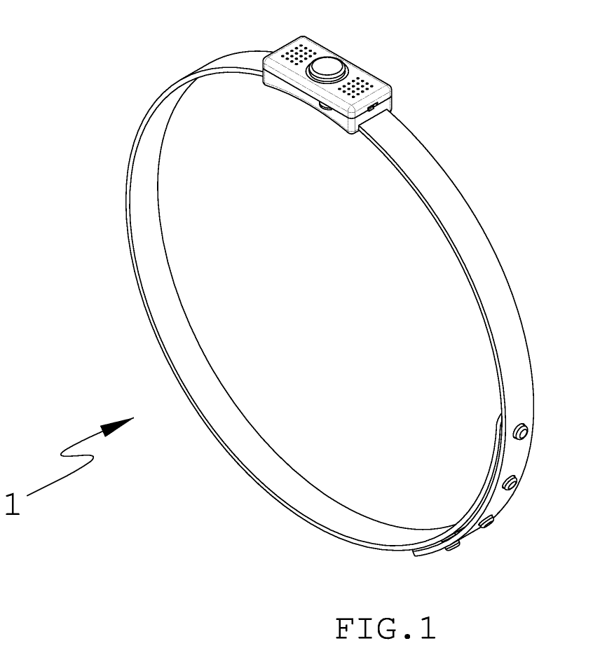

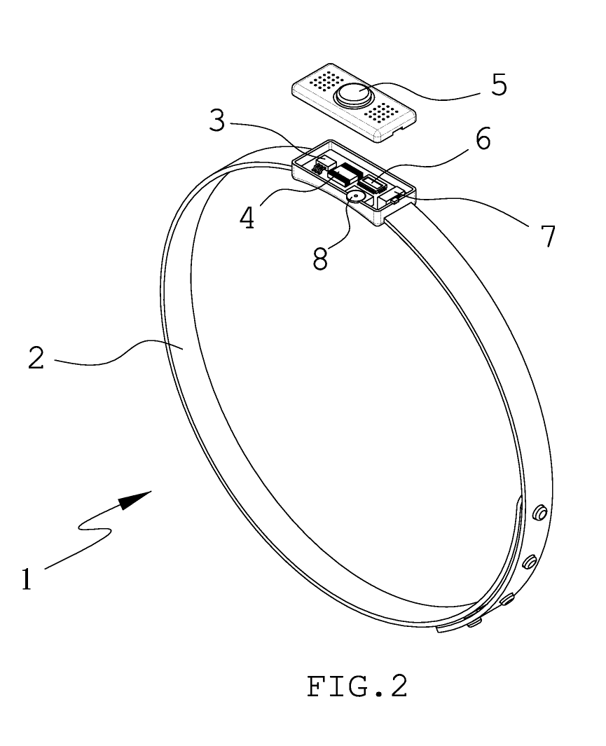

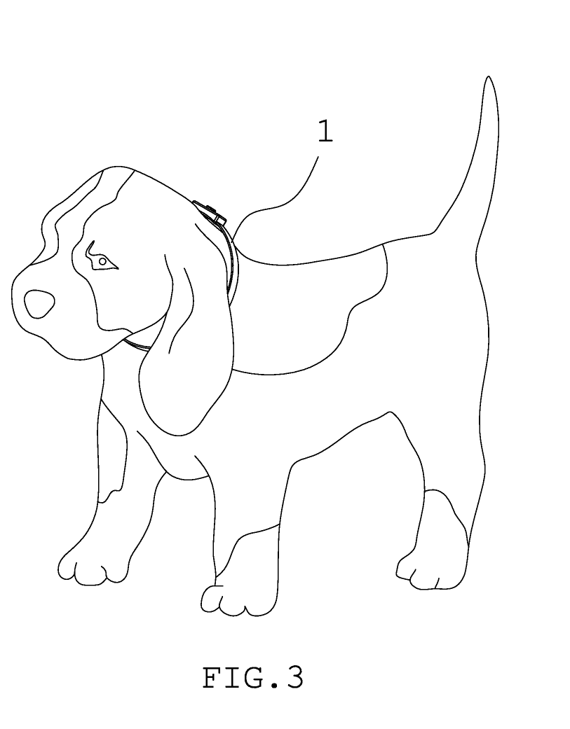

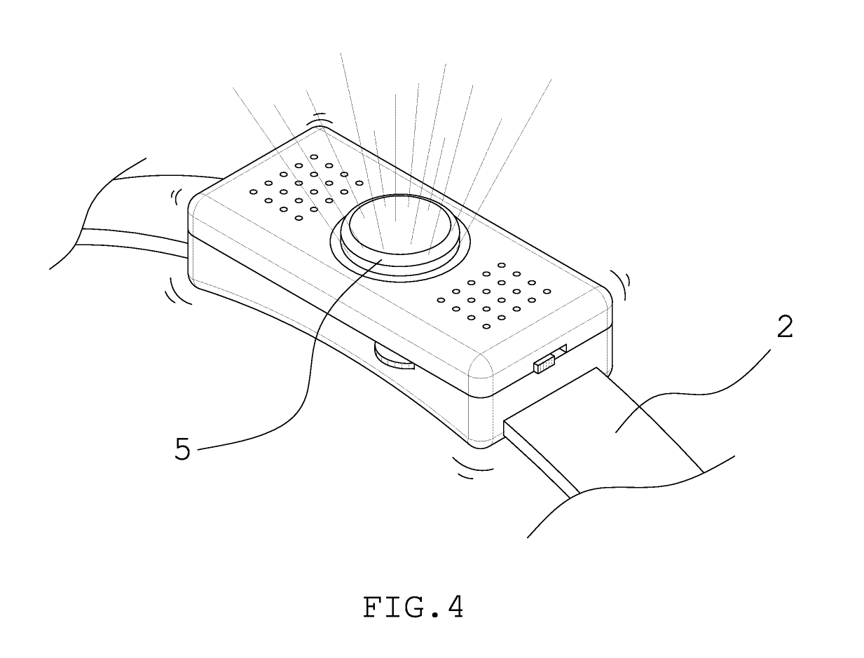

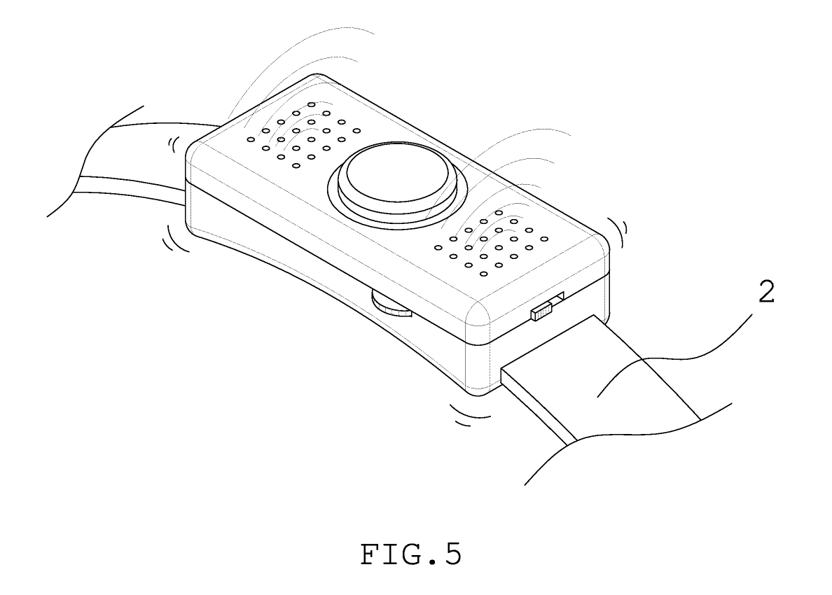

With reference to FIGS. 1 to 5 for a perspective view, an exploded view, and schematic views of a pet safety warning ring in accordance with preferred embodiments of the present invention respectively, the pet safety warning ring 1 comprises:

(1) a collar body 2, being chain-shaped or leash-shaped, and made of germanium titanium silicone, unwoven cloth and plastic material, and having a locking element disposed separately at both ends of the collar body 2 for adjusting the pet collar to be sheathed on a pet's neck with an appropriate length;

(2) a vibration frequency sensor 3, disposed on the collar body 2, and having a magnet installed inside a plastic tube and a coil wound around the exterior of the plastic tube, such that when the pet is moving, the magnet inside the plastic tube and the coil outside the plastic tube will produce an electromagnetic induction, and the sine wave frequency of the current passing through the coil can be measured to calculate the number of steps moved by the pets, so as to predict the moving speed of the pet;

(3) an information transmission module 4, being a built-in module of the collar body 2, and having an end as a receiving terminal coupled to the vibration frequency sensor for converting a received analog signal into digital data, and then transmitting the digital data to another end coupled to a microcontroller chip 6, while converting the analog signal into a simulated signal and transmitting the simulated signal to a warning flash device 5;

(4) a warning flash device 5, coupled to the information transmission module 4, for producing a light warning effect according to information read by the vibration frequency sensor 3, wherein the light warning effect can be achieved by using a blinking or continuously lit LED to indicate the existence of the pet;

(5) a microcontroller chip 6, coupled to the information transmission module 4, for determining whether or not the ultrasonic transmitter 7 is turned on, such that if the microcontroller chip 6 detects that the vibration frequency has reached a specific value, then a turn-on instruction will be transmitted to the ultrasonic transmitter 7;

(6) a sensing adjustment means 8, coupled to the microcontroller chip 6, for changing the specific frequency for turning on the ultrasonic transmitter 7 and adjusting the standard of emitting the ultrasonic wave according to the safety movement range of the pet; and

(7) an ultrasonic transmitter 7, coupled to the microcontroller chip 6, for emitting a ultrasonic wave of 135 dB after the turn-on instruction is received, wherein the pet will feel uncomfortable with such sound and stop running, and the transmission frequency falls within a range of 20000˜25000 Hz, and thus people can hardly observe it.

Firstly, the safety warning ring 1 is sheathed on a pet's neck for monitoring the pet's moving condition. When the pet is moving, the vibration frequency sensor 3 receives a vibration, and the information transmission module 4 transmits the message to the warning flash device 5 and the microcontroller chip 6, such that the warning flash device 5 will indicate the existence of the pet by a blinking LED lamp. If the microcontroller chip 6 detects that the vibration frequency has reached a specific value, a turn-on instruction will be transmitted to the ultrasonic transmitter 7 to emit an ultrasonic wave of 135 dB, such that the pet will feel uncomfortable and stops running. The transmission frequency falls within a range of 20000˜25000 Hz, so that the frequency cannot be heard by human ears or will not cause us any harm. When a pet is running on a wide open grassland, the sensing adjustment means 8 is provided for setting or increasing the specific frequency of the microcontroller chip 6 for emitting ultrasonic waves, so that the pet can be moved at a higher speed in the safe wide open environment.

What is claimed is:

1. A pet safety warning ring, comprising:
a collar body, having a locking element disposed at both ends of said collar body separately, and a warning ring being fixed onto a pet;
a vibration frequency sensor, disposed on said collar body;
an information transmission module, with an end as a receiving terminal coupled to a vibration frequency sensor, and another end as a transmitting terminal coupled to a warning flash device and a microcontroller chip;
a warning flash device, coupled to said information transmission module, for generating a light warning according to information read by the vibration frequency sensor;
a microcontroller chip, coupled to the information transmission module, for determining whether the ultrasonic transmitter is turned on;
a sensing adjustment means, coupled to the microcontroller chip; and
an ultrasonic transmitter, coupled to the microcontroller chip, for emitting an ultrasonic wave after a turn-on instruction is received;
such that when the pet is moving, said vibration frequency sensor receives a vibration to transmit a message to said warning flash device to achieve the effect of alerting a driving car about the existence of the pet; and if a vibration frequency sensed by said warning ring reaches a specific value, the microcontroller chip will turn on said ultrasonic transmitter to emit the ultrasonic wave, such that the pet will feel uncomfortable, and if the pet slows down its movement, said ultrasonic transmitter will stop operation, so as to control the moving speed of the pet and prevent an accident occurred if the pet runs onto a road.

2. The pet safety warning ring of claim 1, wherein said ultrasonic transmitter emits an ultrasonic volume from 130 dB to 140 dB.

3. The pet safety warning ring of claim 1, wherein said ultrasonic transmitter has a transmission frequency at least greater than 20000 HZ.

4. The pet safety warning ring of claim 1, wherein said warning flash device includes at least one outwardly emitted light beam.
